(19) United States
(12) Patent Application Publication
(10) Pub. No.: US 2023/0189717 A1
(43) Pub. Date: Jun. 22, 2023

(54) FLOWERPOT AND MANUFACTURING METHOD THEREOF

(71) Applicant: Zhisheng FAN, Jinhua (CN)

(72) Inventor: Zhisheng FAN, Jinhua (CN)

(21) Appl. No.: 17/738,170

(22) Filed: May 6, 2022

(30) Foreign Application Priority Data
Dec. 22, 2021 (CN) 2021115850526

(51) Int. Cl. A01G 9/02; D03D 1/00; D06M 16/00; D05B 93/00

(52) U.S. Cl. CPC A01G 9/021; D03D 1/00; D06M 16/00; D05B 93/00

(57) ABSTRACT

The present invention provides a flowerpot and a manufacturing method thereof, and relates to the technical field of flowerpots. A flowerpot comprises a flowerpot body provided with an opening, the flowerpot body being woven from ultrafine fibers. The flowerpot of the present invention is light in weight, not easy to corrode, has a long service life, and cannot be broken. The flowerpot can be ventilated around to facilitate the growth of plants. Furthermore, the present invention also proposes a method for manufacturing a flowerpot, comprising the flowerpot described above, further comprising the steps of: weaving ultrafine fibers into a cloth with a loom; washing the woven cloth with water and then subjecting to natural shrinkage; printing the cloth after natural shrinkage; and sewing the printed cloth into a flowerpot body. With this method, it is convenient to manufacture the flowerpot.

### CROSS-REFERENCE TO RELATED APPLICATIONS

The application claims priority to Chinese patent application No. 2021115850526 filed on Dec. 22, 2021, the entire contents of which are incorporated herein by reference.

### TECHNICAL FIELD

The present invention relates to the technical field of flowerpots, and more particularly, to a flowerpot and a manufacturing method thereof.

### BACKGROUND

Flowerpots are utensils for planting flowers, which are generally in the shape of a rounded table or a chamfered table with a large mouth and a small bottom end. Flowerpots are pot-shaped utensils used in private garden villas, and are widely used in gardening greening and landscape engineering, including gardening greening, landscape greening, private gardens, and community greening. Flowerpots for growing flowers come in a variety of forms and sizes. Flower producers or flower gardeners can choose flowerpots according to the characteristics and needs of flowers and the characteristics of flowerpots. According to different production materials, they can be divided into many types.

Among them, the glass fiber reinforced plastic flowerpot is also called FRP flowerpot, of which the texture is made of clay sculpture or mold. This flowerpot has advantages of various styles, strong and durable, no deformation, corrosion resistance, and complete specifications. The surface can have various color effects. The sandstone flowerpot is carved from fine sandstone and has various colors. As the best material in flowerpots, its surface can have effects. The purple sand pot is also called pottery pot, and has advantages of exquisite production, simple and generous, mostly purple, complete specifications. But its water permeability and air permeability are inferior to the tile pot. The purple sand pot is used for planting flowers and trees that prefer to be moist, and can also be used as a pot cover. The porcelain pot is made of porcelain mud, and is externally coated with colored glaze. The porcelain pot has advantages of exquisite workmanship, clean and elegant, and beautiful appearance. The disadvantage is poor drainage and ventilation. The porcelain pot is often used as a cover of a tile pot for decorating flowers indoors or exhibitions.

Glazed pottery pot can be painted with various colors of glaze, with beautiful appearance and various styles. The pottery pot glazed inside and outside has poor drainage and air permeability, which is equivalent to providing a layer of glass inside and outside. There is also a pottery pot that is only glazed on an outer wall. Because an inner wall is unglazed, the essence of the pot is maintained, and it has both the beautiful appearance and the inherent hydrophobic permeability, which is more suitable for long-term placement and planting. Shiwan flowerpot made from Shiwan in Foshan, as one of the best products, is elegant, beautiful, and practical. The plastic pot is light, durable, colorful, inexpensive and easy to use. However, it is impermeable to air and water, which is used more in soilless culture. If it is used to cultivate flowers, it is necessary to pay attention to the physical properties of culture soil to make it loose and breathable, so as to overcome the shortcomings of the plastic pot. Plastic pots are most suitable for planting flowers that are more resistant to water and humidity, such as Cyperus involucratus Rottboll, Monstera deliciosa Liebm., Zantedeschia aethiopica (L.) Spreng., and Aglaonema modestum. In the nursery stage, small soft plastic pots (nutrition pots) are commonly used, which are easy to use.

However, the existing flowerpots have many shortcomings. For example, ceramic flowerpots are not only heavy, but also easily damaged after falling. Many families have children. Such flowerpots are more dangerous for children. Especially after planting flowers on the balconies of high-rise buildings, falling flowerpots can easily injure pedestrians. Moreover, the periphery of the existing flowerpot is generally closed, and the flowers can only vent from the top opening of the flowerpot, which is not conducive to the growth of flowers.

### SUMMARY

It is an object of the present invention to provide a flowerpot which is light in weight, not easy to corrode, has a long service life, and cannot be broken. The flowerpot can be ventilated around to facilitate the growth of plants.

Another object of the present invention is to provide a method for manufacturing a flowerpot, by which the flowerpot is easily manufactured.

The examples of the present invention are realized in that

In a first aspect, an example of the present application provides a flowerpot body provided with an opening, the flowerpot body being woven from ultrafine fibers.

The ultrafine fibers are light in weight. Since the flowerpot body is woven from ultrafine fibers, the woven flowerpot body has low density and light weight. Moreover, after the ultrafine fibers are woven into the cloth, the air permeability is good. After the soil, sand and gravel are placed in the flowerpot body for planting, the outside air can enter the flowerpot body from the surrounding of the flowerpot body, which is convenient for growth of cultivated plants.

The ultrafine fibers are very soft. The flowerpot body woven by using the ultrafine fibers will not be damaged after falling, and is not easy to smash other objects, or cause damage to children, etc., with high safety. The ultrafine fibers have strong corrosion resistance. The woven flowerpot body has a long service life and is not easy to be corroded or damaged. The flowerpot body can be cleaned and reused after being used once, which is conducive to saving production materials, and is environmentally friendly and low in use cost.

Further comprising a cover plate for shielding the opening of the flowerpot body, the cover plate being connected to the flowerpot body.

Further, wherein the cover plate is woven from ultrafine fibers.

Further, wherein one side of the cover plate is fixedly connected to the flowerpot body, and a side face of the cover plate is detachably connected to the flowerpot body.

Further, wherein a hook & loop male fastener is provided at the side face of the cover plate, and the flowerpot body is provided with a hook & loop female fastener mated with the hook & loop male fastener is provided at the flowerpot body.

Further, wherein a snap-in male fastener is provided in the side face of the cover plate, and a snap-in female fastener mated with the snap-in male fastener is provided at the flowerpot body.

Further, wherein the cover plate is provided with a through hole for the plant to pass through.

Further, wherein the cover plate is provided with a separation port in communication with the through hole, the separation port penetrating through the cover plate.

In a second aspect, an example of the present application provides a method for manufacturing a flowerpot comprising the flowerpot described above, further comprising the steps of:

weaving ultrafine fibers into a cloth with a loom;

washing the woven cloth with water and subjecting to natural shrinkage;

printing the cloth after natural shrinkage; and

sewing the printed cloth into a flowerpot body.

After printing the cloth, further comprising:

impregnating the cloth for antimicrobial treatment.

Examples of the present invention have at least the following advantages or benefits over the prior art:

An example of the present invention provides a flowerpot body provided with an opening, wherein the flowerpot body is woven from ultrafine fibers.

The ultrafine fibers are light in weight. Since the flowerpot body is woven from ultrafine fibers, the woven flowerpot body has low density and light weight. Moreover, after the ultrafine fiber is woven into the cloth, the air permeability is good. After the soil, sand and gravel are placed in the flowerpot body for planting, the outside air can enter the flowerpot body from the surrounding of the flowerpot body, which is convenient for growth of cultivated plants.

The ultrafine fibers are very soft. The flowerpot body woven by using the ultrafine fibers will not be damaged after falling, and is not easy to smash other objects, or cause damage to children, etc., with high safety. The ultrafine fibers have strong corrosion resistance. The woven flowerpot body has a long service life and is not easy to be corroded or damaged. The flowerpot body can be cleaned and reused after being used once, which is conducive to saving production materials, and is environmentally friendly and low in use cost.

An example of the present invention also provides a method for manufacturing a flowerpot comprising the flowerpot described above, further comprising the steps of:

weaving ultrafine fibers into a cloth with a loom;

washing the woven cloth with water and subjecting to natural shrinkage;

printing the cloth after natural shrinkage; and

sewing the printed cloth into a flowerpot body.

With this method, it is convenient to manufacture the flowerpot.

### BRIEF DESCRIPTION OF DRAWINGS

FIG. 1 is a schematic structural diagram of an embodiment of a flowerpot provided in an example of the present invention; and

FIG. 2 is a schematic structural diagram of another embodiment of the flowerpot provided in the example of the present invention.

### DETAILED DESCRIPTION OF THE EMBODIMENTS

### Example 1

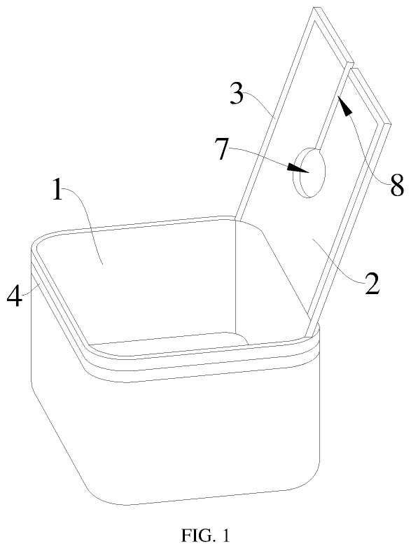

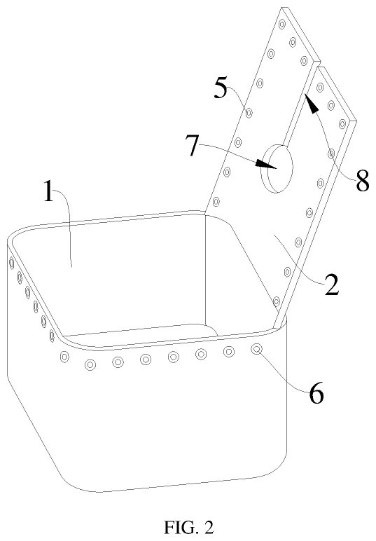

Reference is now made to FIGS. 1 and 2. FIG. 1 is a schematic structural diagram of an embodiment of a flowerpot provided in an example of the present invention; and FIG. 2 is a schematic structural diagram of another embodiment of the flowerpot provided in the example of the present invention.

The example of the present invention provides a flowerpot body provided with an opening 1, and the flowerpot body 1 is woven from ultrafine fibers.

In China's textile industry, fibers with a monofilament fineness less than 0.44 dtex are defined as ultrafine fibers. Most synthetic fibers can be made into ultrafine fibers, such as polyamide, polyester, polypropylene, polyacrylonitrile and other fibers. Ultrafine fibers are mainly divided into ultrafine natural fibers and ultrafine synthetic fibers. Ultrafine natural fibers mainly include animal fibers (spider silk, silk, leather, animal fluff, etc.), plant fibers, etc.; and ultrafine synthetic fibers mainly include polyester, polyamide, polyacrylonitrile, polypropylene, PTFE and glass fiber and other fiber varieties. The largest output in the industry are polyester and polyamide ultrafine fibers.

The ultrafine fibers are light in weight. Since the flowerpot body 1 is woven from ultrafine fibers, the woven flowerpot body 1 has low density and light weight. Moreover, after the ultrafine fibers are woven into the cloth, the air permeability is good. After the soil, sand and gravel are placed in the flowerpot body 1 for planting, the outside air can enter the flowerpot body 1 from the surrounding of the flowerpot body 1, which is convenient for growth of cultivated plants.

The ultrafine fibers are very soft. The flowerpot body 1 woven by using the ultrafine fibers will not be damaged after falling, and is not easy to smash other objects, or cause damage to children, etc., with high safety. The ultrafine fibers have strong corrosion resistance. The woven flowerpot body 1 has a long service life and is not easy to be corroded or damaged. The flowerpot body 1 can be cleaned and reused after being used once, which is conducive to saving production materials, and is environmentally friendly and low in use cost. Optionally, the ultrafine fibers in this example may be fibers such as polyamide, polyester, polypropylene, and polyacrylonitrile.

As shown in FIGS. 1 and 2, in some examples of the present invention, the flowerpot body 1 further includes a cover plate 2 for covering an opening of the flowerpot body 1, and the cover plate 2 is coupled to the flowerpot body 1.

In the present invention, the cover plate 2 is provided, and the cover plate 2 is connected to the flowerpot body 1, so that after a plant is planted, the cover plate 2 can be covered at the position of the opening of the flowerpot body 1, and the soil, sand and stone, etc. at the position of the opening of the flowerpot body 1 are shielded by the cover plate 2. In this way, on the one hand, it prevents soil, sand, etc. from being exposed to the outside, which affects the beauty of the flowerpot, thus improving the ornamental; and on the other hand, the soil and gravel at the opening of the flowerpot body 1 can be shielded by the cover plate 2 to prevent sunlight from irradiating on the soil and gravel, thus preventing the growth of weeds.

As shown in FIGS. 1 and 2, in some examples of the present invention, the cover plate 2 is woven from ultrafine fibers.

In the present invention, the cover plate 2 is woven from ultra-fine fibers, so that the outside air can easily enter the flowerpot body 1 through the cover plate 2 and prevent the air from entering due to the shielding of the cover plate 2.

As shown in FIGS. 1 and 2, in some examples of the present invention, one side of the cover plate 2 is fixedly connected to the flowerpot body 1, and a side face of the cover plate 2 is detachably connected to the flowerpot body 1.

In the present invention, the cover plate 2 is fixedly connected to the flowerpot body 1 at one side, so that the cover plate 2 can always be located on the flowerpot body 1, preventing the cover plate 2 from being dropped or lost. Moreover, the side face of the cover plate 2 is detachably connected to the flowerpot body 1, so that after planting the plants, the cover plate 2 can be rotated about the flowerpot body 1 to cover the opening of the flowerpot body 1. Then, the side face of the cover plate 2 is connected to the flowerpot body 1, and the surrounding of the cover plate 2 is connected to the flowerpot body 1, so that it is convenient to wrap around the opening of the flowerpot body 1.

As shown in FIGS. 1 and 2, in some examples of the present invention, a hook & loop male fastener 3 is provided at the side face of the cover plate 2, and a hook & loop female fastener 4 mated with the hook & loop male fastener 3 is provided at the flowerpot body 1.

In the present invention, the hook & loop male fastener 3 is provided at the side face of the cover plate 2, and the hook & loop female fastener 4 mated with the hook & loop male fastener 3 is provided at the flowerpot body 1, so that after a plant is planted, the cover plate 2 can be rotated about the flowerpot body 1 to shield the opening of the flowerpot body 1. Then all the periphery of the cover plate 2 is connected to the flowerpot body 1 by bonding the hook & loop male fastener 3 on the side face of the cover plate 2 and the hook & loop female fastener 4 of the flowerpot body 1 to each other, so that it is convenient to wrap all the periphery of the opening of the flowerpot body 1. It is also convenient to separate the hook & loop male fastener 3 and the hook & loop female fastener 4 from each other to separate the side face of the cover plate 2 from the flowerpot body 1.

It should be noted that the use of the hook & loop male fastener 3 and the hook & loop female fastener 4 bonded to each other to connect and disconnect the cover plate 2 and the flowerpot body 1 is merely a preferred embodiment of the present example, and the present invention is not limited thereto. In other examples, the connection and disconnection between the cover plate 2 and the flowerpot body 1 may be achieved in other ways.

As shown in FIGS. 1 and 2, in some examples of the present invention, a snap-in male fastener 5 is provided at the side face of the cover plate 2, and a snap-in female fastener 6 mated with the snap-in male fastener 5 is provided at the flowerpot body 1.

In the present invention, the snap-in male fastener 5 is provided at the side face of the cover plate 2, and the snap-in female fastener 6 mated with the snap-in male fastener 5 is provided at the flowerpot body 1, so that after a plant is planted, the cover plate 2 can be rotated about the flowerpot body 1 to shield the opening of the flowerpot body 1. Then all the periphery of the cover plate 2 is connected to the flowerpot body 1 by attaching the snap-in male fastener 5 on the side face of the cover plate 2 and the snap-in female fastener 6 of the flowerpot body 1 to each other, so that it is convenient to wrap all the periphery of the opening of the flowerpot body 1. It is also convenient to separate the snap-in male fastener 5 and snap-in female fastener 6 from each other to separate the side face of the cover plate 2 from the flowerpot body 1. Alternatively, the snap-in male fasteners 5 of the present example are multiple in number and evenly spaced along the side face of the cover plate 2, and the snap-in female fasteners 6 of the present example are multiple in number and evenly spaced along the side face of the flowerpot body 1.

It should be noted that the use of the snap-in male fastener 5 and the snap-in female fastener 6 in snap-fit to connect and disconnect the cover plate 2 and the flowerpot body 1 is merely a preferred embodiment of the present example, and the present invention is not limited thereto. In other examples, the connection and disconnection between the cover plate 2 and the flowerpot body 1 may be achieved in other ways.

As shown in FIGS. 1 and 2, in some examples of the present invention, the above-mentioned cover plate 2 is provided with a through hole 7 for plants to pass through.

In the present invention, the through hole 7 is provided, so that after a plant is planted, the plant can pass through the through hole 7, convenient for the cover plate 2 to shield the opening of the flowerpot body 1.

As shown in FIGS. 1 and 2, in some examples of the present invention, the cover plate 2 is provided with a separation port 8 in communication with the through hole 7, the separation port 8 penetrating through the cover plate 2.

According to the present invention, the cover plate 2 is provided with the separation port 8 in communication with the through hole 7. The separation port 8 penetrates through the cover plate 2, so that after a plant is planted, the plants can pass through the separation port 8 and move to the position of the through hole 7, thus further convenient for the cover plate 2 to shield the opening of the flowerpot body 1.

### Example 2

An example of the present invention also provides a method for manufacturing a flowerpot comprising the flowerpot described above, further comprising the steps of:

weaving ultrafine fibers into a cloth with a loom; washing the woven cloth with water and subjecting to natural shrinkage, wherein, the natural shrinkage can control the weight of the cloth per square centimeter in an appropriate range, so that the dust of the soil will not leak out of the flowerpot body 1; printing the cloth after natural shrinkage; and printing various patterns and the like on the flowerpot body 1 to improve the aesthetic appearance of the flowerpot body 1; and sewing the printed cloth into the flowerpot body 1. With this method, it is convenient to manufacture the flowerpot.

As shown in FIGS. 1 and 2, in some examples of the present invention, after printing the cloth, the method further comprises: impregnating the cloth for antimicrobial treatment. The present invention improves the safety performance of the flowerpot body 1 by impregnating the cloth for antibacterial treatment.

In view of the above, the example of the present invention provides a flowerpot body provided with an opening 1, wherein the flowerpot body 1 is woven from ultrafine fibers.

The ultrafine fibers are light in weight. Since the flowerpot body 1 is woven from ultrafine fibers, the woven flowerpot body 1 has low density and light weight. Moreover, after the ultrafine fibers are woven into the cloth, the air permeability is good. After the soil, sand and gravel are placed in the flowerpot body 1 for planting, the outside air can enter the flowerpot body 1 from the surrounding of the flowerpot body 1, which is convenient for growth of cultivated plants.

The ultrafine fibers are very soft. The flowerpot body 1 woven by using the ultrafine fibers will not be damaged after falling, and is not easy to smash other objects, or cause damage to children, etc., with high safety. The ultrafine fibers have strong corrosion resistance. The woven flowerpot body 1 has a long service life and is not easy to be corroded or damaged. The flowerpot body 1 can be cleaned and reused after being used once, which is conducive to saving production materials, and is environmentally friendly and low in use cost.

The present example also provides a method for manufacturing a flowerpot comprising the above-mentioned flowerpot, further comprising the steps of: weaving ultrafine fibers into a cloth with a loom; washing the woven cloth with water and subjecting to natural shrinkage, wherein, the natural shrinkage can control the weight of the cloth per square centimeter in an appropriate range, so that the dust of the soil will not leak out of the flowerpot body 1; printing the cloth after natural shrinkage; and printing various patterns and the like on the flowerpot body 1 to improve the aesthetic appearance of the flowerpot body 1; and sewing the printed cloth into the flowerpot body 1. With this method, it is convenient to manufacture the flowerpot.

What is claimed is:

1. A flowerpot, comprising a flowerpot body provided with an opening, wherein the flowerpot body is woven from ultrafine fibers.

2. The flowerpot of claim 1, further comprising a cover plate for shielding the opening of the flowerpot body, the cover plate being connected to the flowerpot body.

3. The flowerpot of claim 2, wherein the cover plate is woven from ultrafine fibers.

4. The flowerpot of claim 2, wherein one side of the cover plate is fixedly connected to the flowerpot body, and a side face of the cover plate is detachably connected to the flowerpot body.

5. The flowerpot of claim 4, wherein a hook & loop male fastener is provided at the side face of the cover plate, and the flowerpot body is provided with a hook & loop female fastener mated with the hook & loop male fastener is provided at the flowerpot body.

6. The flowerpot of claim 4, wherein a snap-in male fastener is provided in the side face of the cover plate, and a snap-in female fastener mated with the snap-in male fastener is provided at the flowerpot body.

7. The flowerpot of claim 2, wherein the cover plate is provided with a through hole for the plant to pass through.

8. The flowerpot of claim 7, wherein the cover plate is provided with a separation port in communication with the through hole, the separation port penetrating through the cover plate.

9. The method for manufacturing a flowerpot of claim 1, comprising the steps of:
weaving ultrafine fibers into a cloth with a loom;
washing the woven cloth with water and subjecting to natural shrinkage;
printing the cloth after natural shrinkage; and
sewing the printed cloth into a flowerpot body.

10. The method for manufacturing a flowerpot of claim 9, characterized in that: after printing the cloth, further comprising:
impregnating the cloth for antimicrobial treatment.
